(19) United States
(12) Patent Application Publication
(10) Pub. No.: US 2019/0262732 A1
(43) Pub. Date: Aug. 29, 2019

(54) SQUEAKER TOY AND METHOD OF PRODUCING SAME

(71) Applicant: Playgro, Heatherton (AU)

(72) Inventor: Gavin Trakman, Heatherton (AU)

(21) Appl. No.: 15/904,805

(22) Filed: Feb. 26, 2018

(51) Int. Cl. A63H 9/00; A61J 17/00

(52) U.S. Cl. CPC A63H 9/00; A63H 5/00; A61J 17/001

(57) ABSTRACT

A toy includes a noise emitting mechanism sealed within a hollow chamber of a water-impenetrable body and methods of making the same. The toy advantageously retains the functionality and appeal of a squeaky toy, but reduces the risk associated with air, moisture, saliva, bacteria, and/or water being drawn into the toy during play and providing an environment for mold and bacteria to grow within the toy.

### TECHNICAL FIELD

This disclosure relates to a hermetically sealed squeaker toy with a noise-emitting feature and method of making the same.

### BACKGROUND

Toys comprising noise-emitting features, like squeakers, are popular among children as teething devices. In many conventional squeaker toys, a squeaking sound is emitted when the toy is compressed to cause air to pass through a small air hole. In some such toys, the air hole is incorporated directly in a wall of a hollow body of the toy to allow the passage of air into and out of the hollow body when the toy is compressed. The problem is that the hole allows moisture to enter the interior of the hollow body, which can lead to growth of mold, mildew and bacteria inside of the toy. Once inside the toy, mold and bacteria is difficult to thoroughly remove. Therefore, there exists a need for toys that provide the enjoyment of a noise-emitting feature without the problem of moisture penetration and mold growth inside of the toy.

### SUMMARY

I provide a toy comprising a water-impenetrable body having a hollow chamber, and a noise emitting mechanism sealed within the hollow chamber of the water/moisture-impenetrable body.

I also provide a method of making a toy comprising forming a body having a hollow chamber from a water-impermeable material, inserting a noise emitting mechanism through an opening in the body into the hollow chamber of the body, and sealing the opening of the body to provide a water/moisture-impenetrable body having a noise emitting mechanism sealed therein.

### DRAWINGS

FIG. 1 shows a front view of an exemplary toy of this disclosure.

FIG. 2 shows a cross sectional view of the toy depicted in FIG. 1.

### DETAILED DESCRIPTION

This disclosure relates to a toy comprising a noise-emitting feature that addresses the problems of moisture penetration and mold, mildew and bacteria growth inside of the toy. Instead of providing a toy with an opening where air, moisture, saliva, bacteria, or water can be drawn into the toy. We provide a squeaking device within a water/moisture-impenetrable body. By doing so, we retain the functionality and appeal of a squeaky toy, but reduce the risk associated with air, moisture, saliva, bacteria, and/or water being drawn into the toy during play and providing an environment for mold and bacteria to grow within the toy.

As will be apparent to those skilled in the art, our toys and methods reside in the combination of parts set forth in this disclosure and covered by the claims appended hereto, it being understood that changes in the precise structure and steps herein disclosed may be made within the scope of what is claimed without departing from the spirit of the disclosure.

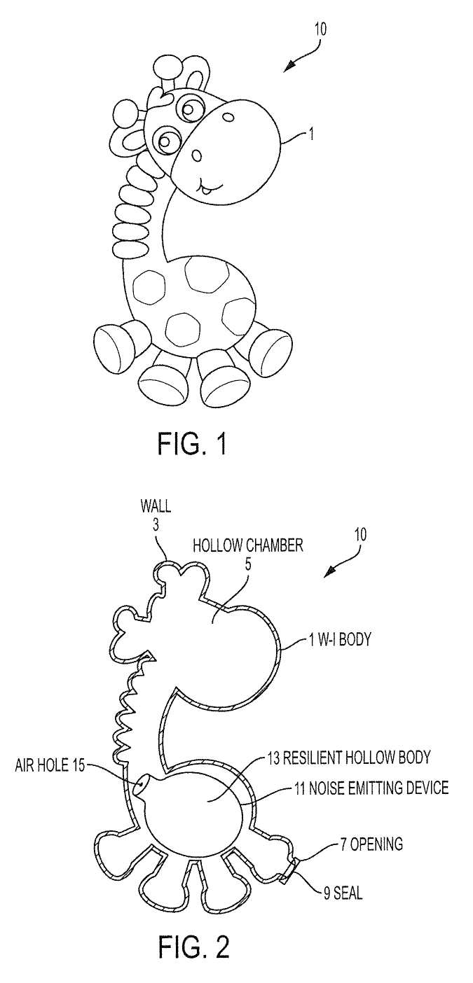

Referring to FIGS. 1-2, an example of a toy 10 of this disclosure is depicted. In FIG. 1, the toy 10 is in the form of a giraffe, although it would be understood that the shape of the toy is not limited. Suitable alternative shapes include other types of animals, people, inanimate objects and the like.

As seen best in FIG. 2, the toy 10 comprises a water-impenetrable body 1 having a wall 3 enclosing a hollow chamber 5. If the wall 3 comprises one or more openings 7 allowing communication between the hollow chamber 5 and the external environment, the openings 7 are sealed by a seal 9 to provide the water-impenetrable body 1.

As used herein, “water-impenetrable body” means that the body provides a water-impenetrable barrier that prevents the passage of water or moisture from the external environment into the hollow chamber 5 of the toy 10. That is, the water-impenetrable body is sealed from the external environment such that water is not only unable to pass through the walls of the body, but also unable to pass through any openings in the body. Likewise, the water-impenetrable body may also be impermeable to air.

The water-impenetrable body 1 of toy 10 is composed of a water-impermeable material. Additionally, the material composing the water-impenetrable body 1 may be flexible such that the body 1 is resiliently compressible and/or resiliently expansible. Suitable materials include rubber, silicone, polyolefin, polypropylene, elastomeric material, polyvinyl chloride and combinations thereof and the like.

A noise emitting mechanism 11 is sealed within the hollow chamber 5 of the water-impenetrable body 1. Any known noise emitting mechanism may be used, including but not limited to mechanical or electronic devices.

A suitable noise emitting mechanism 11 is a squeaker comprising a resilient hollow body 13 having an air hole 15. The air hole 15 enables air to pass into and out of an interior of the resilient hollow body 13 to create an audible squeaking sound. Compression of the resilient hollow body 13 by an external force causes air to exit the resilient hollow body 13, while the release of the compressive force allows air to re-enter the resilient hollow body 13 as it returns to its original shape.

As the noise emitting mechanism 11 is disposed within the hollow chamber 5 of the water-impenetrable body 1, a compressive force externally applied to the water-impenetrable body 1 may be transferred to the noise emitting mechanism 11 and cause air to pass between an interior of the resilient hollow body 13 and the hollow chamber 5 of water-impenetrable body 1. This allows for an audible squeaking sound without introducing air and moisture from the external environment into the hollow chamber 5.

The noise emitting mechanism 11 may be formed separately from the water-impenetrable body 1 and may be able to move within the hollow chamber 5 of the water-impenetrable body 1. Alternatively, the noise emitting mechanism 11 may be adhered or otherwise attached to an internal surface of the wall 3 of the water-impenetrable body 1. It is also possible for the noise emitting mechanism 11 to be provided as an additional integral hollow chamber (not shown) of the water-impenetrable body 1 with the air hole 15 provided in an internal wall between the respective hollow chambers. In such an example, air is permitted to move between adjacent hollow chambers to emit an audible sound when one of the chambers is compressed, but air cannot flow externally of the water-impenetrable body 1 and air and moisture from the external environment is not introduced into the hollow chambers.

The noise emitting mechanism 11 may be resiliently compressible and/or resiliently expansible. Suitable materials include rubber, silicone, polyolefin, polypropylene, elastomeric material, polyvinyl chloride and combinations thereof and the like.

Suitable methods of manufacturing the toy 10 will now be described.

A body 1 having a wall 3 and hollow chamber 5 may be formed from a water-impermeable material. Suitable forming techniques include injection molding, blow-molding, cast molding and other known techniques. Typically, a body 1 formed by such techniques comprises an external opening 7 in the wall 3 of the body 1 that allows for communication between the hollow chamber 5 and the external environment.

A noise emitting mechanism 11 may be inserted through the opening 7 and disposed within the hollow chamber 5 of the body 1. The noise emitting mechanism 11 can be manufactured by separately molding a resilient hollow body by known techniques.

Due to the presence of opening 5, body 1 is not water-impenetrable and must be sealed to provide a water-impenetrable body. The opening 7 may be sealed by any suitable technique, including but not limited to application of a resin or glue and optionally a patch or by melting such as by application of heat by laser or the like. Sealing of the opening 7 provides a toy 10 having the functionality and appeal of a squeaky toy, but without the risk associated with air, moisture, saliva, bacteria, and/or water being drawn into the toy during play and providing an environment for mold and bacteria to grow within the toy.

I claim:

1. A toy comprising:
a water-impenetrable body having a hollow chamber, and
a noise emitting mechanism sealed within the hollow chamber of the water-impenetrable body.

2. The toy according to claim 1, wherein the noise emitting mechanism comprises a resilient hollow body having an air hole that enables air to pass between an interior of the noise emitting mechanism and the hollow chamber to emit an audible sound.

3. The toy according to claim 1, wherein the water-impenetrable body is composed of a material selected from the group consisting of rubber, silicone rubber, polyolefin, polypropylene, elastomeric material, polyvinyl chloride and combinations thereof.

4. The toy according to claim 1, wherein the water-impenetrable body is resiliently expansible.

5. The toy according to claim 1, wherein the water-impenetrable body is resiliently compressible.

6. The toy according to claim 1, wherein noise emitting mechanism is capable of moving within the hollow chamber of the water-impenetrable body.

7. The toy according to claim 1, wherein noise emitting mechanism is attached to an internal wall of the water-impenetrable body.

8. The toy according to claim 1, wherein the noise emitting mechanism is a second hollow chamber of the water-impenetrable body and an air hole is provided between the hollow chambers of the water-impenetrable body.

9. A method of making the toy according to claim 1, comprising:
forming a body having a hollow chamber from a water-impermeable material,
inserting a noise emitting mechanism through an opening in the body into the hollow chamber of the body, and
sealing the opening of the body to provide a water-impenetrable body having a noise emitting mechanism sealed therein.

10. The method according to claim 1, wherein the body is molded by one selected from the group consisting of injection molding, blow-molding and cast molding.
